(19) United States
(12) Patent Application Publication
(10) Pub. No.: US 2005/0068229 A1
(43) Pub. Date: Mar. 31, 2005

(54) Providing location assistance information to a mobile station

(75) Inventors: Jani Moilanen, Helsinki (FI); Marianne Talvitie, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/728,314

(22) Filed: Dec. 5, 2003

(30) Foreign Application Priority Data
Sep. 30, 2003 (FI) 20031417

(51) Int. Cl. G01S 5/14

(52) U.S. Cl. 342/357.15

(57) ABSTRACT

A method for providing location assistance information to a mobile station of a communications network is discussed. Visibilities of a plurality of satellites of a satellite positioning system with respect to the mobile station are estimated. A group of said plurality of satellites with the best estimated visibilities with respect to the mobile station is selected, and location assistance information relating to at least said group of satellites is sent to the mobile station.

### BACKGROUND OF THE INVENTION

1. Field of the Invention

The present invention relates to providing location assistance information to a mobile station.

2. Description of the Related Art

Positioning services have become very popular in the recent years. Positioning refers here to determining the location of a receiver device. The receiver device may be capable of determining its position based on signals it receives. The signals can be sent either from a specific positioning system or, for example, from a cellular communications system. Alternatively, the receiver device may act as a measurement device and send measurement results to a further unit, which then determines the location of the receiver device.

Positioning services may be used simply for locating a receiver device. The location of the receiver device may, for example, be shown on a map at the display of the receiver device. Alternatively, it is possible to provide location-dependent services, for example, for users of a communication system. The location of the receiver device may affect the content of a location-dependent service. A further option is that the location of the receiver device is used for determining whether the service is provided to the receiver device at all.

The most widely used positioning system is the Global Positioning System (GPS). GPS positioning is based on measuring relative time of arrival of signals sent simultaneously from GPS satellites. The locations of the GPS satellites at the time of sending the signal can be determined. It is possible to determine the location of the GPS receiver by determining the distance between GPS satellites and the GPS receiver using time of arrival measurement results together with the exact GPS time.

In theory, three time of arrival measurements would be enough to calculate the GPS receiver's position and also the velocity, if the exact GPS time is known to the GPS receiver. In practice, a GPS receiver has low-cost, low-accuracy local oscillator as a local clock. Therefore a fourth time of arrival measurement is needed to determine the difference between the local time and the GPS time. This means that for successfully locating a GPS receiver, it needs to receive signals simultaneously from at least four GPS satellites.

GPS signaling is based on a code division multiple access (CDMA) principle. This means that all the GPS satellites are transmitting at same carrier frequencies, but the signals are separated from each other by coding. A GPS satellite transmits two right-hand circularly polarized L-band signals known as L1 at 1575.42 MHz and as L2 at 1227.6 MHz. Both L1 and L2 signal are bi-phase shift key signals modulated with pseudo-random noise (PRN). L2 is modulated with a Precision-code (P-code), which has a rate of 10.23 MHz and a repeat time of one week. In practice, P-code is encrypted and it is accessible only for authorized users. The L1 signal is modulated with a coarse/acquisition (C/A) code signal, which is a 1023 chips long PRN signal repeating itself every millisecond thus having a rate of 1.023 MHz. C/A-code is not encrypted, so it is available also for unauthorized users. The L1 signal also contains the encrypted P-code and to make the C/A orthogonal with the encrypted P-code, C/A-code is phase shifted by 90 degrees. Both the L1 and L2 signals also carry a navigation message modulo-2 added with C/A-code and the encrypted P-code.

The navigation message includes both data unique to the transmitting satellite and data common to all satellites. The navigation message contains time information, satellite clock correction data, ephemeris (precise orbital parameters), almanac (coarse orbital parameters), health data for all satellites, coefficients for the ionospheric delay model and coefficients to calculate the Universal Coordinated Time (UTC) from the GPS system time. The navigation message consists of 25 frames, and the frames are organized in such a way that a GPS receiver is able to obtain satellite-specific data (ephemeris) for exact position calculation within 30 seconds. This 30 seconds is the minimum time-to-first-fix (TTFF) of GPS in the general case. It takes 12.5 minutes to receive all the 25 frames completely.

As mentioned above, GPS positioning is dependent on obtaining accurate GPS time and navigation data and on performing distance measurements. For carrying out GPS positioning successfully, signals from three or four GPS satellites need to be received properly for demodulating navigation data needed for the distance measurements. GPS provides accurate positioning results especially in rural areas, where a GPS receiver can have a line-of-sight with the needed number GPS satellites. In urban areas, where buildings may cause attenuation of the GPS signals and reflections to the signal propagation paths, especially the reception of the navigation data may not be successful.

The distance measurements need to be performed at the GPS receiver, but the GPS time and navigation data may be provided to the GPS receiver also via another system. In Assisted GPS (AGPS), at least part of the GPS time and/or navigation data is provided as location assistance data to a GPS receiver by means of some other signals than by the GPS satellite signals. By providing navigation data and/or exact GPS time as location assistance information, the availability and the response time of GPS positioning can be enhanced. By obtaining location assistance information, a GPS receiver can perform distance measurements and optionally also calculate its position even when the GPS signals the GPS receiver receives are so weak that the navigation message cannot be properly demodulated.

A cellular telecommunications system, for example, may be used for transmitting the location assistance information. The cellular telecommunications system may be equipped with a plurality of reference GPS receivers for obtaining the location assistance information. Typically each reference GPS receiver is associated with a serving area. The location assistance information sent to GPS receivers within a serving area typically includes information relating to those GPS satellites, from which the reference GPS receiver of the respective serving area is able to successfully receive GPS signals. The GPS receivers, to which location assistance information is transmitted using a cellular telecommunications network, are typically integrated to mobile stations of the cellular telecommunications network.

Consider a GPS receiver needing location assistance information. The GPS receiver may receive signals from different GPS satellites than those covered by a reference GPS receiver providing the location assistance information. In such a case, it is possible that the GPS receiver does not receive a sufficient amount of location assistance information for successfully, accurately and quickly locating itself or for performing distance measurements.

This problem has been partly addressed in U.S. Pat. No. 6,215,441. There a land based telephone system is used for providing location assistance information to mobile GPS receivers. Information about GPS satellites is obtained from a number of GPS reference receivers forming a GPS reference network. Location assistance information is sent to a mobile station about appropriate satellites. The appropriate GPS satellites are determined based on the approximate location of the mobile GSP receiver. The approximate location of the mobile GPS receiver may be determined from the cell identifier of the land based telephone system cell communicating with the mobile GPS receiver.

An object of certain embodiments of the present invention is to overcome problems relating to providing location assistance information.

### SUMMARY OF THE INVENTION

In accordance with a first embodiment of the invention, there is provided a method for providing location assistance information to a mobile station of a communications network, the method including the steps of:
estimating visibilities of a plurality of satellites with respect to the mobile station, the plurality of satellites being satellites of a satellite positioning system,
selecting a group of the plurality of satellites with the best estimated visibilities with respect to the mobile station, and
sending to the mobile station location assistance information relating to at least the group of satellites.

In accordance with a second embodiment of the present invention, there is provided a network element for providing location assistance information to a mobile station of a telecommunications network, the network element being configured to
estimate visibilities of a plurality satellites with respect to a mobile station, the satellites being satellites of a satellite positioning system,
select a group of the plurality of satellites with the best estimated visibilities with respect to the mobile station, and
send to a mobile station location assistance information relating to at least the group of satellites.

In accordance with a third embodiment of the present invention, there is provided a communications system for providing location assistance information, the communications system including
at least one reference receiver of a satellite positioning system for obtaining location assistance information relating to satellites of the satellite positioning system,
means for estimating visibilities of a plurality of satellites of the satellite positioning system with respect to a mobile station,
means for selecting a group of the plurality of satellites with the best estimated visibilities with respect to the mobile station, and
means for sending to the mobile station location assistance information relating to the group of satellites.

### BRIEF DESCRIPTION OF THE DRAWINGS

Embodiments of the present invention will now be described by way of example only with reference to the accompanying drawings, in which:

FIG. 1 shows as an example a cellular telecommunications system, where embodiments of the invention are applicable;

FIG. 2 shows, as examples, two serving areas relating to two reference satellite positioning system receivers;

FIG. 3 shows a flowchart of a method in accordance with an embodiment of the invention; and

FIG. 4 shows a block chart of a network element in accordance with an embodiment of the invention.

### DETAILED DESCRIPTION OF THE PREFERRED EMBODIMENTS:

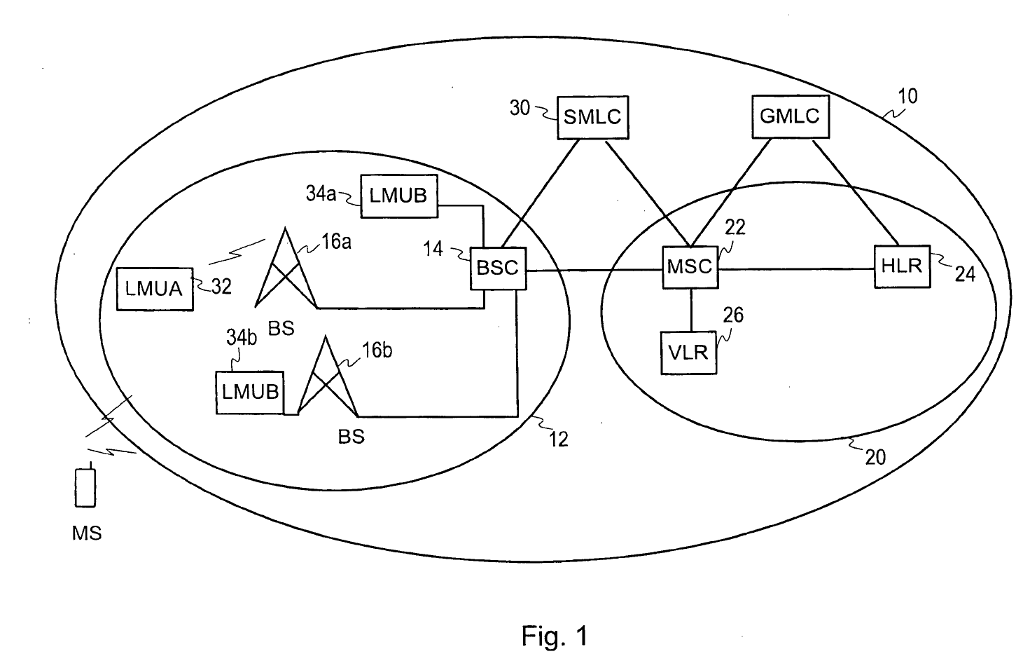

FIG. 1 illustrates, as an example, a schematic view of a cellular telecommunications network 10 supporting positioning services. The cellular telecommunications network 10 contains a radio access network 12 and a core network 20. The radio access network 12 has a plurality of base station controllers (BSC) 14 responsible for controlling the radio resources. A base station controller 14 may control a plurality of base stations (BS) 16, which are typically connected to a base station controller with a fixed line connection or, for example, with a point-to-point radio or microwave link. A base station controller 14 is responsible for controlling and managing the radio resources in a base station 16. The core network 20 contains Mobile Switching Centers (MSC) 22, a Home Location Register (HLR) 24 and Visitor Location Registers (VLR) 26. FIG. 1 illustrates, as an example, only one BSC, MSC and VLR.

It is appreciated that the names of the network elements of a cellular telecommunications network may vary. The naming of the network elements in connection with FIG. 1 is in accordance with the Global Mobile Telecommunications System (GSM), but similar network elements are found also in other cellular telecommunication systems. For example, in Universal Mobile Telecommunications System (UMTS) a transceiver is called a node B, and network element responsible for controlling radio resources is a Radio Network Controller. It is evident to a person skilled in the art that in FIG. 1 a GSM network is used as an example of a cellular telecommunications system.

Location services architecture is logically implemented in the GSM network 10 through the addition of one network node, the Mobile Location Center (MLC) 30. A MLC can be either a Serving MLC (SMLC) or a Gateway MLC (GMLC). The SMLC manages the overall coordination and scheduling of resources required to perform positioning of a mobile station. The SMLC typically calculates the final estimate and accuracy for the location of a mobile station. The GMLC is a node, which an external LCS client accesses for obtaining location information about a mobile station. The GMLC obtains location area of the mobile station from Home Location Register after proper authentication, and can then obtain information about the location of the mobile station from the serving MLC.

For positioning a mobile station MS of a cellular telecommunications network using a satellite positioning system, the mobile station needs to be provided with functionality to receive and process signals from satellite positioning system satellites. A mobile station may be equipped with a satellite positioning system receiver or sensor. A mobile station equipped with a satellite positioning system receiver has the full functionality of a satellite positioning system receiver. A mobile station equipped with a satellite positioning system receiver may thus locate itself without location assistance information, if it receives signals from positioning system satellites successfully. A mobile station equipped with a satellite positioning system sensor is typically capable of determining distances from the positioning system satellites. The distance measurement results are transmitted to a further computing element, where the location of the satellite positioning system sensor is determined. The further computing element is often called a location server.

For providing location assistance information to the mobile station, the telecommunication network is equipped with reference satellite positioning system receivers. In the location services architecture for GMS, which is shown in FIG. 1, these reference satellite positioning system receivers are called Location Management Units (LMU). Additionally or alternatively, an LMU may support other positioning algorithms than algorithms using a satellite positioning system.

The location architecture 3GPP (3^{rd} Generation Partnership Project) specification TS 03.71 defines two types of LMUs in Section 5 “General LCS architecture”. An LMU of Type A is exclusively accessed over the normal GSM air interface. This means that the Type A LMU is connected over the air interface to a serving base station. A base station controller provides signaling access for the controlling SMLC. FIG. 1 illustrates this with the Type A LMU 32 and BS 16a. Type A LMU is typically located at a fixed position at a distance from other GSM network elements. A Type B LMU is accessed over the Abis interface, which means that Type B LMU is connected to the BSC. Type B LMU may be a standalone device or integrated to a base station. This is illustrated in FIG. 1 with Type B LMU 34a, which is located at a fixed position at a distance from other GSM network elements and connected to BSC 14, and with Type B LMU 34b, which is connected to the base station 16b. Signaling to a Type B LMU is by means of messages routed through the controlling BSC. An LMU supporting GPS positioning may, in principle, be a LMU of type A or type B.

It is evident that in other location service architectures, the network elements having similar functionality as the Mobile Location Center or the Location Management Unit may have different names. Below term location server is used to refer to a network element providing functionality relating to positioning of a mobile station.

Below the GPS system is used as an example of a satellite positioning system. An LMU supporting GPS positioning comprises a reference GPS receiver, and it is called an AGPS LMU. All location and assistance measurements obtained by an AGPS LMU are supplied to a particular SMLC associated with the LMU. Instructions concerning the timing, the nature and any periodicity of these measurements are either provided by the SMLC or other location server or are pre-administered in the LMU.

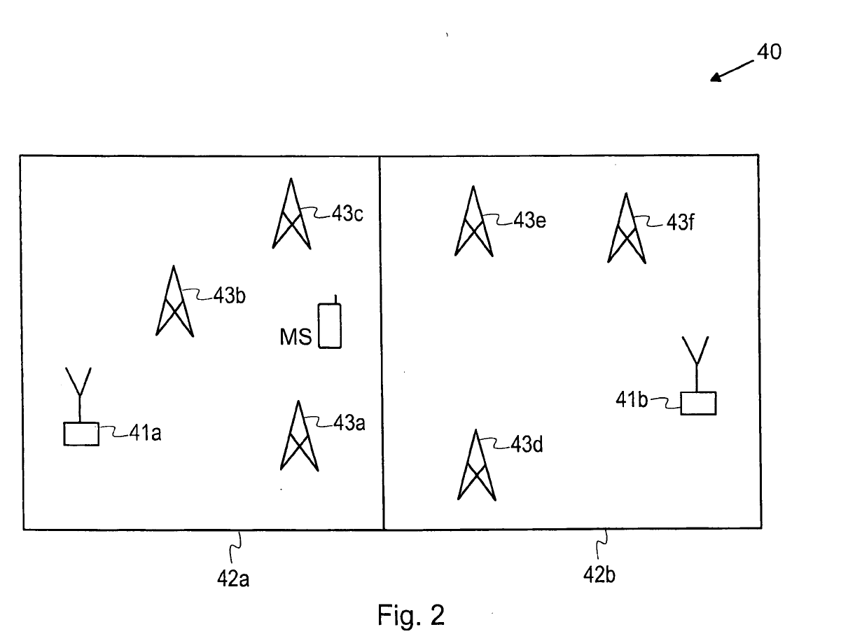

FIG. 2 shows an example of serving areas in a cellular telecommunications system 40 equipped for Assisted GPS. The cellular telecommunications system 40 has a plurality of reference GPS receivers. FIG. 2 shows, as examples, two reference GPS receivers 41a, 41b. These reference GPS receivers 41a, 41b correspond to the LMU 32 in the location architecture for GSM system shown in FIG. 1. Each reference GPS receiver 41a, 41b typically has a respective serving area 42a, 42b. The location assistance information transmitted via the cellular network 40 is obtained from the reference GPS receivers 41. The cellular network transmitters 43 in FIG. 2 correspond to the base stations 16 in FIG. 1.

The location assistance information is provided to the mobile stations MS either in point-to-point fashion or by broadcast. When location assistance information is provided point-to-point, a mobile station typically requests a location server to provide location assistance information. Alternatively, the location server may initiate sending of location assistance data. This is feasible in a situation, for example, where the location server receives from an entity outside the cellular telecommunications system a request to locate the mobile station. The location server then typically provides location assistance information relating to the reference GPS receiver at whose serving area the mobile station is at the time of requesting the assistance information. The location assistance information is transmitted to the mobile station typically via the same base station which is used for other communications between the mobile station and the cellular telecommunications network. In some telecommunications network, a mobile station may be simultaneously in communications with a plurality of base stations. In this case, the location assistance information to the mobile station may be transmitted via one or more of base stations belonging to the plurality of base stations.

When location assistance information is broadcast, the transmitters 43 in each serving area 42 transmit assistance data obtained from the reference GPS receiver 41 of the respective service area. A mobile station can thus receive location assistance information without requesting it from a location server.

Referring to FIG. 2, location assistance information sent to a mobile station in the serving area 42a typically relates to the reference GPS receiver 41a. Location assistance information sent to a mobile station in the serving area 42b typically relates to the reference GPS receiver 41b.

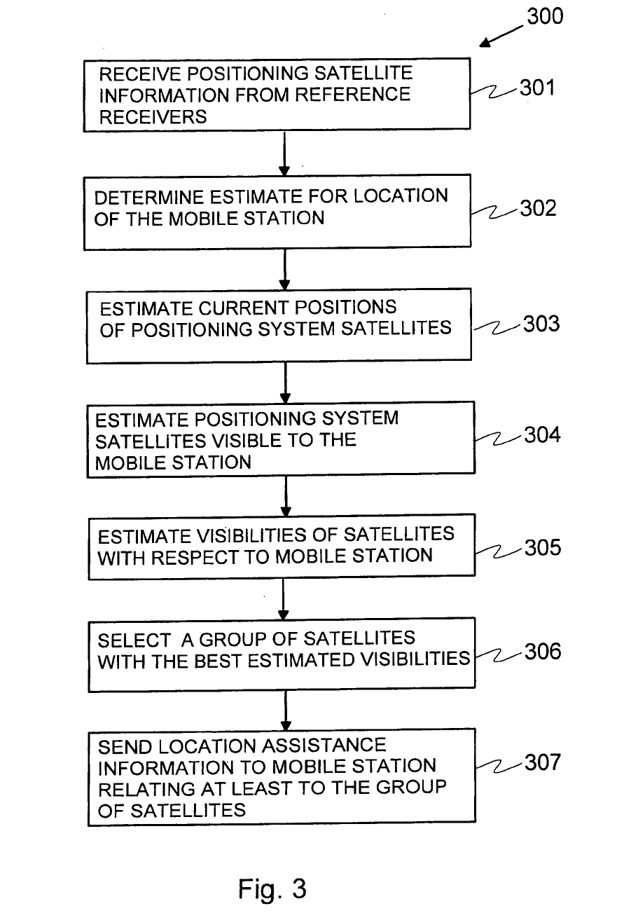

Referring to FIG. 3, an embodiment of the invention is next discussed. FIG. 3 shows a flowchart of a method 300 in accordance with an embodiment of the invention. In step 301 satellite positioning signals are received by reference satellite positioning receivers. This information is typically sent to a location server. For sending location assistance information to a mobile station, an estimate for the location of the mobile station is determined in step 302. This mobile station location estimate may be based on information received from a cellular telecommunications network or from other communications network.

Based on the information obtained from the reference satellite positioning system receivers in step 301, it is possible to estimate the current locations of positioning system satellites in step 303. Typically an estimate is determined for each positioning system satellite relating to which information has been obtained from the reference receivers. In other words, a location estimate is typically determined for each positioning system satellite visible to the reference receivers providing information to the location server. The step 303 thus need not be related to any specific mobile station, but the results of step 303 may be used for providing location assistance information to any mobile station. In GPS system, for example, the current locations of the GPS satellites can be estimated using the well known methods relating to GPS positioning.

Based on the mobile station location estimate and on the estimate of the current location of the positioning system satellites, it is estimated in step 304, which positioning system satellites may be visible to the mobile station in the estimated location. An example of estimating satellites visible to a mobile station is to calculate the elevation angle of a satellite with respect to the mobile station location. Calculation of the elevation angle is straightforward mathematics. A suitable criterion for a satellite to be visible to a mobile station is that the elevation angle of the satellite is more than about 5 degrees, in some cases more than about 10 or 15 degrees.

It should be noted that the elevation angle estimation is typically done without any specific information about the surroundings of the mobile station. There may thus be some buildings or other obstructions, which hinder reception of signals from some positioning system satellites. The calculation of the elevation angle is fast and straightforward, and it provides a necessary criterion for a satellite to be visible to a mobile station. Using this elevation angle estimation, location assistance information relating to some satellites, which are not visible to the mobile station, may be provided to the mobile station. It should be noted, however, that this location angle estimation ensures that in most cases location assistance information of all satellites actually visible to a mobile station is provided to the mobile station.

In addition to calculating the elevation angle of a satellite, it is possible to take into account the presence of large obstructions in the vicinity of the estimated location of the mobile station. For example, a database containing information about the large obstructions and their locations may be provided. It is noted, however, that the estimated location of the mobile station needs to be quite accurate for accurate estimations about screening due to large obstructions.

It may be possible to estimate satellites visible to a mobile station using alternatively other methods than methods based on the elevation angle of a satellite.

In step 305 visibilities of satellites with respect to the mobile station are estimated. The visibility of a satellite with respect to a mobile station refers here to a probability that the mobile station is able to properly decode the signal received from a positioning system satellite. It may be sufficient to use the elevation angle of a satellite as a measure of visibility. This means that a satellite having a high elevation angle is interpreted to have a good visibility. Alternatively, it is possible to take into account, for example, some large obstructions in the vicinity of the mobile station when estimating satellite visibilities with respect to the mobile station.

In step 306 a group of satellites is selected from the satellites estimated to be visible to a mobile station. This selection is based on the estimated visibilities, and the group contains a number of satellites with the best estimated visibilities with respect to the mobile station. This group of satellites contains the satellites most likely to be visible to the mobile station. The positioning system satellites are thus prioritized based on their visibilities for sending location assistance information to a mobile station.

The group of satellites with best estimated visibilities may be selected in a variety of ways. It is possible that the number of satellites in the group is predetermined. This number may be, for example, the minimum number N of satellites needed for positioning a mobile station. Alternatively, the predetermined number may be specified by the size of location assistance information messages. For example, if a location assistance message can contain information about M satellites, the number of satellites in the group may be M. A further option for selecting the group is to define a threshold: all satellites having an estimated visibility above the threshold value are selected to the group.

In step 307 location assistance information about the group of satellites with the best estimated visibilities with respect to the mobile station is sent to the mobile station. The order, in which location assistance information is sent about the satellites of this group, may be independent of the estimated visibilities. Alternatively, location assistance information about the group of satellites may be sent in a descending order with respect to the estimated visibilities.

Location assistance information is sent at least about the minimum number of satellites needed for positioning the mobile station. For Assisted GPS the minimum number of satellites would thus be either three or four, depending on whether the mobile station knows the accurate GPS time. In addition to location assistance information relating to the group of satellites having the best estimated visibilities with respect to the mobile station, location assistance information is typically sent also about further satellites. It is possible, for example, to select a further group of satellites with the next best estimated visibilities with respect to the mobile station. This further group would thus contain satellites being next most likely to be visible to the mobile station. It is possible to select even more groups of satellites, satellites in each group having the next best estimated visibilities with respect to the mobile station, and send location information relating to these groups to the mobile station.

Location assistance information may be sent about all satellites estimated to be visible to the mobile station. In this case location assistance information is sent first about the positioning system satellites having the best estimated visibilities.

Location assistance information is often sent in location assistance messages having a certain message structure and a certain size. If location assistance information is sent about a number of satellites in one location assistance message, the mobile station can typically proceed with the positioning only after the whole message has been received. In GSM, for example, it takes about 15 to 60 seconds to send location assistance information about 16 satellites. Sending location assistance information about all visible satellites in one location assistance message would thus not shorten much the time-to-first-fix.

Location assistance information relating to the minimum number of satellites N needed for locating a mobile station may be sent to a mobile station in one location assistance message. In this embodiment, a first location assistance message thus contains information about a first group of satellites, these satellites being the N₁ (≧N) satellites having the highest visibility probabilities. A second location assistance message contains information about a second group of satellites, these satellites being the N₂ (≧N) satellites having the next highest visibility probabilities. The numbers of satellites N₁ and N₂ need not be equal. If a mobile station would be able to receive signals from all the satellites relating to the first location assistance message, positioning of the mobile station would be possible after receipt of the first location assistance message. This way the time-to-first-fix would be decreased compared to an un-assisted case. If the mobile station, in contrast to the estimation, would not be able to receive signals from all satellites relating to the first location assistance message, positioning of the mobile station would be most likely successful after the receipt of the second location assistance message. Even in this case, the time-to-first-fix might be shorter than in an un-assisted case or than in a case where location assistance information about all satellites is sent in one message. It is possible that the second location assistance message is sent to the mobile station always after the first location assistance message. Alternatively, the second location assistance message may be sent only upon request.

In addition to the location assistance information relating to N satellites, it is possible that a location assistance information message contains some further location assistance information.

In a further embodiment of the invention, the length of the location assistance message may dictate the number of satellites M of which location assistance information may be sent in one location assistance message. For providing location assistance information to a mobile station in an efficient manner, the satellites estimated to be visible to a mobile station may be grouped into groups having M or less satellites, M being the number of satellites dictated by the message structure and size. For example, in GSM a Radio Resource LCS Protocol (RRLP) message may be about 240 bytes long. Location assistance information, which in GSM GPS positioning is called the navigation model, for one GPS satellite requires about 70 bytes. A RRLP message may thus contain location assistance information of three GPS satellites. As discussed above, including assistance information about three satellites having the best estimated visibilities into one location assistance message enables fast and efficient positioning.

Location assistance messages may comprise location assistance information relating to a number of positioning system satellites. In embodiments of the invention relating to providing location assistance information in a point-to-point manner, the first location assistance message sent to a mobile station after a location assistance information request typically contains information about the positioning system satellites having the best estimated visibilities. The next location assistance message to be sent to the mobile station typically contains information about the positioning system satellites having the next best estimated visibilities. The GSM LCS point-to-point messages are examples of location assistance messages containing location assistance information relating to a number of satellites.

Location assistance messages comprising information of a number of satellites may also be sent when location assistance information is broadcasted in a telecommunications network. In this case, it may be advantageous to send periodically those location assistance messages, which contain information about the satellites most likely to be visible to a mobile station in the broadcasting area. Further location assistance messages, sent in between the location assistance messages relating to the positioning system satellites having the best estimated visibilities, may then contain location assistance relating to satellites having lower estimated visibilities. For example, every other location assistance message may contain information about the positioning system satellites most probably visible to the mobile station. This way a mobile station starting to receive location assistance information broadcast is likely to receive information about the most relevant satellites quite fast. It may also be possible that the location assistance message sent first after updating location assistance information, for example, in a location server comprises information about the positioning system satellites most likely to be visible to a mobile station in the broadcasting area.

Location assistance messages may alternatively contain location assistance information relating to one satellite only. It is possible to use this kind of location assistance messages in embodiment of the invention. This means that location assistance information relating to the selected group of satellites is sent using a sequence of location assistance messages, each location assistance message containing information about one selected satellite.

A further option is that a location assistance message contains information relating to all those satellites about which location assistance information will be sent to a mobile station. The order, in which location assistance information is present in the location assistance message, may be dependent on the estimated visibilities with respect to the mobile station.

In some location assistance broadcast methods, location assistance messages containing information about only one satellite and location assistance messages containing information about a number of satellites are used. Part of location assistance information relating to each positioning system satellite, of which information will be sent to the mobile station, may be sent in a location assistance message containing information about a number of satellites. The rest of the location assistance information relating to the specific positioning system satellite is sent in a location assistance message containing information of one satellite only. The GSM LCS broadcast, for example, is implemented with these two kinds of location assistance messages.

Location assistance messages containing location assistance information relating to only one satellite may be used in various ways for efficiently broadcasting location assistance information, similarly as location information messages containing location assistance information relating to a number of satellites as discussed above. For example, location assistance information relating to the positioning system satellites most likely to be visible to a mobile station may be sent more often than location assistance information relating to positioning system satellites less likely to be visible to a mobile station in the broadcasting area.

The location assistance information is received typically by a plurality of reference satellite positioning system receivers, and the location assistance information relating to the satellites estimated to be the most likely visible to the mobile station is selected from the available location assistance information. It is appreciated that location assistance information may be sent only about those satellites, which are estimated to be visible to a mobile station. Alternatively, in addition to sending location assistance information about satellites estimated to be visible to a mobile station, location assistance information may be sent about other satellites visible to a reference satellite positioning system receiver of the serving area where the mobile station is currently located.

Furthermore, if the number of satellites visible to a mobile station is larger than the number of satellites needed to locate the mobile station, location assistance information of only some of the visible satellites may be sent to the mobile station. As discussed above, location assistance information relating to those satellites most probably visible to the mobile station may be sent, while information relating to satellites less probably visible is not sent at all or may be sent later in further location assistance messages.

As mentioned above, location assistance information may be provided to a specific mobile station using a point-to-point connection or to an unspecified number of mobile stations using broadcast. When a point-to-point connection is used, a mobile station usually requests location assistance information from a location server. The location server then carries out method 300 in response to the location assistance information request. It should be noted that although step 303 does not require information about a specific mobile station or its location, it is necessary to estimated the current locations of the positioning system satellites often enough to provide accurate estimates for the satellite locations. Therefore, it may be advisable to perform step 303 also in response to a location assistance information request.

When location assistance information is provided using a point-to-point connection, a rough estimation for the location of the mobile station in step 302 may be determined using information obtainable from the communications network. In a GSM network, the location estimation may be, for example, based on Cell ID, Timing Advance or RX-level information. In a UMTS network, the location estimation may be based on Cell Identity or on Round Trip Times. The accuracy of these location estimates is typically from few hundred meters to a couple of kilometers.

When location assistance information is broadcast in the cellular telecommunications network, the location of a mobile station, to which location assistance information is sent, may be estimated in step 302 based on the broadcasting area. For example, the mass center of a broadcasting area may be used as an estimate for the location of the mobile station for determining satellites visible to the mobile station in step 304. For broadcasting location assistance information, it is possible to carry out steps 301-307 independently of any mobile station requesting the location assistance information. Method 300 is typically repeated periodically at regular intervals for providing accurate location assistance information for broadcasting. The period of broadcasting location assistance information typically depends on the capacity of the broadcasting channel. It is furthermore possible that changes in the satellite visibilities triggers broadcasting of location assistance information relating to the satellites having the best estimated visibilities. The changes in the satellite visibilities change the preferred order in which location assistance information is to be sent.

It is noted that especially in the broadcast case the network element, which carries out method 300, need not be a specific location server. The functionality may be provided, for example, in one network element within the broadcasting area. A base station controller of a GSM network or an additional unit connectable to a base station controller is one possible network element for providing the functionality relating to method 300. Alternatively, a location server may be provided for performing calculations in a central manner. The location server may be integrated, for example, to a mobile switching center MSC.

Information about the satellite positioning signals received by at least one reference receiver need to be provided to the location server or to the network elements, to which the location assistance information delivery is distributed. In a centralized solution, where the location server determines positioning system satellites visible to a mobile station and determines location assistance information for the mobile station, only the location server needs to receive information from the reference receivers. For point-to-point location assistance information delivery, the location server then sends the location assistance information to the mobile station via the communications network. For broadcasting location assistance information, a location server centrally determining relevant location assistance information provides the location assistance information to the broadcasting areas. In a distributed solution, which is especially applicable to broadcasting assistance information, each broadcasting transmitter may be provided with a connection to a number of reference receivers and may determine the location assistance information to be broadcast.

It is noted that the satellite selection in the point-to-point case is typically more accurate than in the broadcast case. The size of a broadcasting area for location assistance information is typically the cell size of the cellular telecommunication system. The cell size may vary typically from a hundred meters to tens of kilometers.

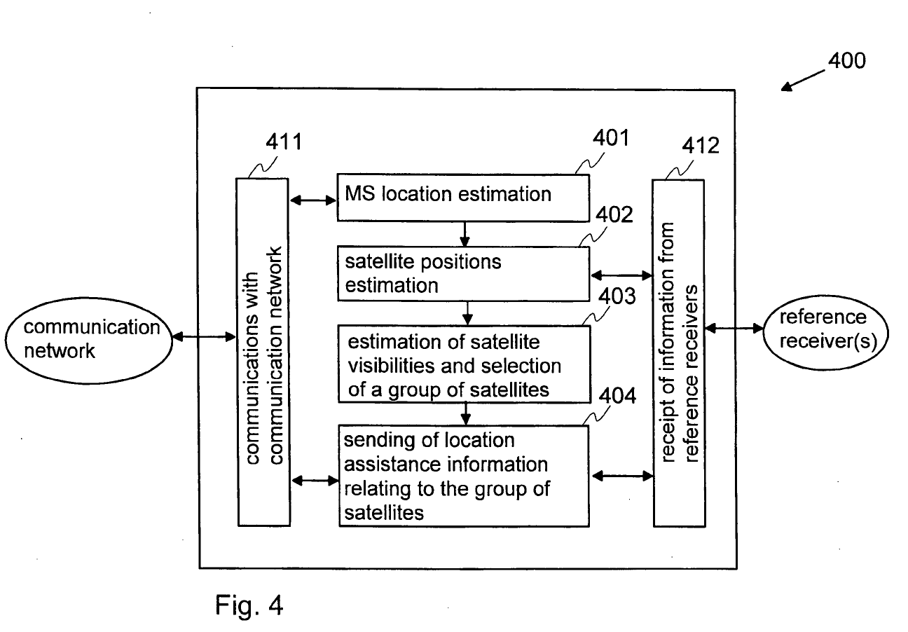

FIG. 4 shows a block chart of a network element 400 in accordance with an embodiment of the invention. The network element 400 may be a location server or, for example, a network element relating to a location assistance information broadcasting area. The network element 400 has means 411 for communicating with a telecommunications network. Furthermore, it has means 401 for determining an estimate for the location of a mobile station. Typically this estimation is based on information received from a communications network. For broadcasting location assistance information, the means 401 may be configured to contain information about the broadcasting area. In this case means 401 or the network element 400 need not necessarily receive information from the telecommunications network.

The network element 400 has furthermore means 412 for receiving information from at least one reference satellite positioning system receiver. The network element 400 is provided also with means 402 for estimating current positions of positioning system satellites based on information received from at least one reference receiver. Means 403 are arranged for estimation of satellites visible to a mobile station at the estimated location, for estimation of visibilities of the satellites with respect to the mobile station and for selecting a group of satellites with the best estimated visibilities with respect to the mobile station. The network element 400 is further provided with means 404 for sending location assistance information relating to at least the selected group of satellites to the mobile station. Means 401-404 are typically provided as suitable software.

The content of the location assistance information depends on the satellite positioning system and on the details of the positioning method. The location of the mobile station may be determined in the mobile station. In this case the positioning is called MS-based positioning. Determining the location of a mobile station in a further computing element (typically in a location server) based on measurement results provided by the mobile station is called MS-assisted positioning. Typically the location assistance information a mobile station needs is different depending on whether the positioning is MS-based or MS-assisted. It should be noted, however, that in each case the mobile station needs to receive relevant location assistance data about satellite positioning system satellites visible to the mobile station.

For example, in Assisted GPS the location assistance data sent to the mobile station is different, when the positioning is MS-based and when it is MS-assisted. The GPS location assistance information for a MS-assisted positioning is Reference Time, Reference Location, DGPS corrections, Navigation Model, Ionospheric Model, UTC Model, Almanac, and Real Time Integrity. The GPS location assistance information for a MS-based positioning comprises Aqcuisition Assistance and typically also Real Time Integrity.

By estimating which positioning system satellites are most likely to be visible to a mobile station, more useful location assistance information can be sent to the mobile station. The accuracy of positioning is increased, as location assistance information is sent about relevant satellites. Positioning may also be carried out faster, as discussed below. If location assistance information is sent only about those satellites, which are estimated to be visible to a mobile station, network resources may also be saved. This is because no location assistance information is sent relating to positioning system satellites which are estimated to be poorly visible.

Furthermore, location assistance information sent to a mobile station may be obtained from a number of reference satellite positioning system receivers. It is therefore possible to locate the reference receivers more widely apart than, for example, in a system, where the serving area of a reference receiver determines the positioning system satellites about which location assistance information is sent to a mobile station. The satellites about which location assistance information is sent are selected in the embodiment of the invention in real time. There is no need for predetermined reference satellite positioning system receiver—transmitter relations. This improves operability of the positioning system.

Furthermore, sending location assistance information first about the satellites most likely to be visible to a mobile station enables fast positioning as a mobile station receives the most relevant point-to-point location assistance information first. In the broadcast location assistance information case, a mobile station may need to, wait a shorter time for the most relevant broadcast location assistance information as the most relevant location assistance information may be sent more often than location assistance information relating to satellites being less likely to be visible to the mobile station.

In certain embodiments of the invention, for determining satellites visible to the mobile station there usually is need to have access to a plurality of reference satellite positioning system receivers, the plurality having at least two reference receivers.

It is appreciated that in the above description GPS positioning system is used as an example of a satellite positioning system. The invention is, however, applicable to providing location assistance information with respect to any satellite positioning system. It is also noted that the exact content and the use of the location assistance information may depend on the satellite positioning system and on whether the positioning is MS-based or MS-assisted.

It is also appreciated that in the above description and in the appended claims the term visible refers to a satellite the level of whose signal at a mobile station is sufficiently high for the mobile station to decode the satellite's signal. For a satellite to be visible to a mobile station, the mobile station may have a line of sight connection with the satellite or the mobile station may, for example, receive a strong reflected signal. In the case of line of sight, the term visibility refers to the probability that a satellite has a line of sight connection with a mobile station. More generally, the term visibility refers here to the probability of a mobile station receiving a strong signal from the satellite. It is evident that satellites need not be visible to the eye for a mobile station to be able to receive signals from the satellites.

It is also appreciated that a cellular telecommunications network has been used above as an example of a communications network capable of delivering location assistance information. It should be noted, however, that also communications networks providing wireless access to a mobile station may be used.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for providing location assistance information to a mobile station of a communications network, the method comprising the steps of:
estimating visibilities of a plurality of satellites with respect to a mobile station, said plurality of satellites being satellites of a satellite positioning system,
selecting a group of said plurality of satellites with best estimated visibilities with respect to the mobile station, and
sending to the mobile station location assistance information relating to at least said group of satellites.

2. The method as defined in claim 1, wherein, in the selecting step, said group of satellites includes a predetermined number of satellites.

3. The method as defined in claim 1, wherein, in the sending step, location assistance information relating to said group of satellites is sent in a location assistance message.

4. The method as defined in claim 1, wherein, in the sending step, location assistance information relating to said group of satellites is sent using a plurality of location assistance messages, each location assistance message of said plurality of location assistance messages including information about one satellite of said satellite positioning system.

5. The method as defined in claim 1, wherein, in the sending step, location assistance information relating to said group of satellites is sent in response to receipt of a location assistance information request from the mobile station.

6. The method as defined in claim 1, wherein, in the sending step, location assistance information relating to said group of satellites is sent periodically.

7. The method as defined in claim 1, wherein, in the sending step, location information relating to said group of satellites is sent in an order dependent on the estimated visibilities with respect to the mobile station.

8. The method as defined in claim 1, further comprising the step of:
selecting a further group of satellites with the next best estimated visibilities with respect to the mobile station.

9. The method as defined in claim 8, wherein, in the sending step, location assistance information relating to said group of satellites is sent to the mobile station before location assistance information relating to said further group of satellites.

10. The method as defined in claim 8, wherein, in the sending step, location assistance information relating to said group of satellites is sent in a first location assistance message and location assistance information relating to said further group of satellites is sent in a second location assistance message.

11. The method as defined in claim 8, wherein, in the sending step, location assistance information is sent using a plurality of location assistance messages, each location assistance message of said plurality of location assistance messages including information about one satellite of said satellite positioning system.

12. The method as defined in claim 8, wherein, in the sending step, location assistance information relating to said group of satellites is sent in response to receipt of a location assistance information request from the mobile station.

13. The method as defined in claim 12, wherein, in the sending step, location assistance information relating to said further group of satellites is sent to the mobile station upon a request for location assistance information relating to said further group.

14. The method as defined in claim 8, wherein, in the sending step, location assistance information relating to said group of satellites is sent periodically.

15. The method as defined in claim 14, wherein, in the sending step, location assistance information relating to said further group of satellites is sent as often as location assistance information relating to said group of satellites.

16. The method as defined in claim 14, wherein, in the sending step, location assistance information relating to said further group of satellites is sent less often than location assistance information relating to said group of satellites.

17. The method as defined in claim 8, wherein, in the sending step, location information relating to said group of satellites and to said further group of satellites is sent in an order dependent on the estimated visibilities with respect to the mobile station.

18. The method as defined in claim 1, wherein, in the selecting step, said group of satellites contains between three and four satellites of the satellite positioning system.

19. The method as defined in claim 1, further comprising the step of:
estimating visibilities of the satellites based on elevation angles of the satellites with respect to an estimated location of the mobile station.

20. The method as defined in claim 19, wherein, in the estimating step, obstructions in a vicinity of the estimated location of the mobile station are taken into account in estimating visibilities of the satellites with respect to the mobile station.

21. The method as defined in claim 1, wherein, in the sending step, said location assistance information is for a mobile-assisted location method.

22. The method as defined in claim 1, wherein, in the sending step, said location assistance information is for a mobile-based location method.

23. A network element for providing location assistance information to a mobile station of a communications network, the network element comprising:
a processor for estimating visibilities of a plurality of satellites with respect to a mobile station, said plurality of satellites being satellites of a satellite positioning system,
a controller for selecting a group of said plurality of satellites with best estimated visibilities with respect to the mobile station, and
a transmitter for sending to a mobile station location assistance information relating to at least said group of satellites.

24. The network element as defined in claim 23, further comprising:
a receiver for receiving location assistance information relating to satellites of said satellite positioning system.

25. The network element as defined in claim 23, wherein the network element is a location server.

26. A communications system for providing location assistance information, the system comprising
at least one reference receiver of a satellite positioning system for obtaining location assistance information relating to satellites of the satellite positioning system,
means for estimating visibilities of a plurality of satellites of the satellite positioning system with respect to a mobile station,
means for selecting a group of said plurality of satellites with best estimated visibilities with respect to the mobile station, and
means for sending to the mobile station location assistance information relating to said group of satellites.

27. The communications system as defined in claim 26, wherein said means for estimating visibilities of satellites with respect to the mobile station are provided in a location server.

28. The communications system as defined in claim 26, wherein said means for estimating visibilities of satellites with respect to the mobile station are provided in a number of network elements.
